(19) United States
(12) Patent Application Publication
(10) Pub. No.: US 2024/0200205 A1
(43) Pub. Date: Jun. 20, 2024

(54) WATER ELECTROLYSIS APPARATUS

(71) Applicant: TOYOTA JIDOSHA KABUSHIKI KAISHA, Toyota-shi (JP)

(72) Inventors: Nobuyuki KITAMURA, Minamitsuru-gun (JP); Mikio WAKAMATSU, Seto-shi (JP)

(73) Assignee: TOYOTA JIDOSHA KABUSHIKI KAISHA, Toyota-shi (JP)

(21) Appl. No.: 18/501,617

(22) Filed: Nov. 3, 2023

(30) Foreign Application Priority Data
Dec. 20, 2022 (JP) 2022-203057

(51) Int. Cl. C25B 1/04; C25B 9/70; C25B 15/02; C25B 15/08

(52) U.S. Cl. CPC C25B 1/04; C25B 9/70; C25B 15/02; C25B 15/083

(57) ABSTRACT

A water electrolysis apparatus includes: a water electrolysis stack; a water supply side path; a hydrogen side path; an electric power source that applies the voltage to the water electrolysis stack; and a controller that controls application voltage of the electric power source, in which at times of startup and stop of the water electrolysis apparatus, the controller controls the voltage of the electric power source such that an average change rate of a current density is higher in a region where the current density is equal to or lower than half of a current density at a time of steady operation of the water electrolysis apparatus than in a region where the current density is higher than half of the current density at the time of the steady operation.

### CROSS-REFERENCE TO RELATED APPLICATION

This application claims priority to Japanese Patent Application No. 2022-203057 filed on Dec. 20, 2022, incorporated herein by reference in its entirety.

### BACKGROUND

### 1. Technical Field

The present disclosure relates to a water electrolysis apparatus.

### 2. Description of Related Art

At the time of startup or stop of a water electrolysis apparatus, the hydrogen concentration in oxygen gas that is emitted rises in some cases. Japanese Unexamined Patent Application Publication No. 2010-236089 (JP 2010-236089 A) discloses that a low voltage allowing hydrogen not to be generated is applied until the cathode pressure becomes the same as the anode pressure (or until a predetermined time elapses) after the stop of hydrogen supply from the cathode, for restraining the retention of high-pressure hydrogen leaked to the anode side, in a cathode pressure reduction process after the stop of the operation of the water electrolysis apparatus.

### SUMMARY

In the technology in JP 2010-236089 A, a low voltage is applied, and the electrolysis reaction is performed at a low current. Therefore, the ratio of cross leakage (the mixing of hydrogen to an oxygen electrode side of water electrolysis cells) increases.

In view of the related art, the present disclosure has an object to provide a water electrolysis apparatus that can restrain the mixing of hydrogen to an oxygen side path (water supply side path).

As a result of keen examination, the inventor has known that the ratio of cross leakage increases particularly when the current density is low at times of startup and stop of the water electrolysis apparatus, and has solved the problem by the following specific means.

The present patent application discloses a water electrolysis apparatus that performs water electrolysis in which hydrogen and oxygen are obtained by supplying water to water electrolysis cells and applying voltage to the water electrolysis cells, the water electrolysis apparatus including: a water electrolysis stack in which the water electrolysis cells are stacked; a water supply side path through which water is supplied to the water electrolysis stack; a hydrogen side path through which hydrogen generated from the water electrolysis stack is collected; an electric power source that applies the voltage to the water electrolysis stack; and a controller that controls application voltage of the electric power source, in which at times of startup and stop of the water electrolysis apparatus, the controller controls the voltage of the electric power source such that an average change rate of a current density is higher in a region where the current density is equal to or lower than half of a current density at a time of steady operation of the water electrolysis apparatus than in a region where the current density is higher than half of the current density at the time of the steady operation.

The present patent application discloses a water electrolysis apparatus that performs water electrolysis in which hydrogen and oxygen are obtained by supplying water to water electrolysis cells and applying voltage to the water electrolysis cells, the water electrolysis apparatus including: a water electrolysis stack in which the water electrolysis cells are stacked; a water supply side path through which water is supplied to the water electrolysis stack; a hydrogen side path through which hydrogen generated from the water electrolysis stack is collected; an electric power source that applies the voltage to the water electrolysis stack; and a controller that controls application voltage of the electric power source, in which at times of startup and stop of the water electrolysis apparatus, the controller controls the electric power source such that an average change rate of a current density is higher in a region where the current density is equal to or lower than 0.4 A/cm² than in a region where the current density is higher than 0.4 A/cm² and is equal to or lower than a current density at a time of steady operation of the water electrolysis apparatus.

The present patent application discloses a water electrolysis apparatus that performs water electrolysis in which hydrogen and oxygen are obtained by supplying water to water electrolysis cells and applying voltage to the water electrolysis cells, the water electrolysis apparatus including: a water electrolysis stack in which the water electrolysis cells are stacked; a water supply side path through which water is supplied to the water electrolysis stack; a hydrogen side path through which hydrogen generated from the water electrolysis stack is collected; an electric power source that applies the voltage to the water electrolysis stack; and a controller that controls application voltage of the electric power source, in which the controller controls the electric power source such that a current density reaches 0.4 A/cm² within 5 seconds at a time of startup of the water electrolysis apparatus and the water electrolysis apparatus reaches a stopped state within 5 seconds after the current density reaches 0.4 A/cm² at a time of stop of the water electrolysis apparatus.

The above water electrolysis apparatus may include a valve that decreases a hydrogen pressure of the hydrogen side path, and at the time of the stop of the water electrolysis apparatus, the controller may further perform a control to actuate the valve and decrease the hydrogen pressure of the hydrogen side path, before the current density is decreased or before the current density reaches 0.4 A/cm² after the current density starts to be decreased.

With the present disclosure, it is possible to restrain the mixing of hydrogen to the oxygen side path (water supply side path).

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram for describing the configuration of a water electrolysis apparatus 10;

FIG. 2 is a sectional view for describing the layer configuration of a water electrolysis cell 11;

FIG. 3 is a conceptual diagram for describing the configuration of a controller 30;

FIG. 4 is a diagram for describing a control of a current density according to an aspect 1;

FIG. 5 is a diagram for describing a control of the current density according to an aspect 2; and

FIG. 6 is a diagram for describing a control of the current density according to an aspect 3.

### DETAILED DESCRIPTION OF EMBODIMENTS

### 1. Configuration of Water Electrolysis Apparatus

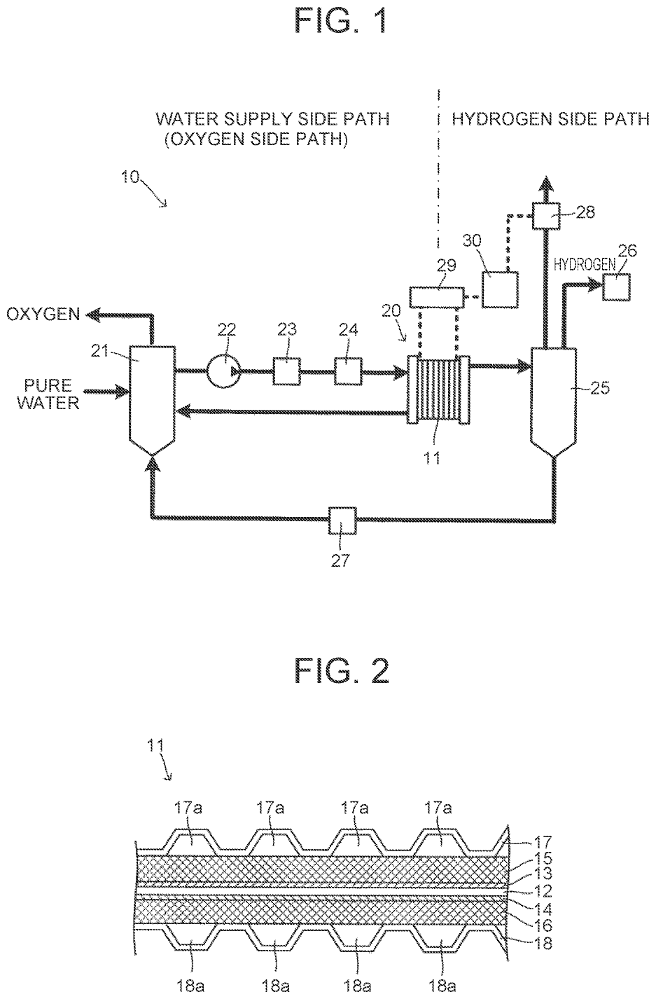

FIG. 1 conceptually shows a water electrolysis apparatus 10 according to an embodiment. Known principles and ideas can be adopted as a basic principle and idea relevant to the generation of hydrogen and oxygen by water electrolysis that is performed the water electrolysis apparatus 10. In the embodiment, the water electrolysis apparatus 10 includes a water electrolysis stack 20 in which a plurality of water electrolysis cells 11 is stacked and both ends of the water electrolysis cells 11 are sandwiched by endplates, a water supply side path (oxygen side path) on one side of the water electrolysis stack 20, and a hydrogen side path on the other side. In the water electrolysis apparatus 10, water is supplied from the water supply path to the water electrolysis cells 11 included in the water electrolysis stack 20, and energization is performed by an electric power source 29, so that water is decomposed into hydrogen and oxygen. The obtained hydrogen is exhausted to the hydrogen side path, is collected, and is stored.

On the water supply side path (oxygen side path), city water is changed to pure water, for example, through ion exchanger, and the pure water is stored in a gas-liquid separator 21, and then is supplied to the water electrolysis stack 20 through a cooler 23 and an ion exchanger 24 by a water pump 22. The oxygen and water having got out of the water electrolysis stack 20 are returned to the gas-liquid separator 21, and are separated into gas and liquid. The gas (oxygen) is exhausted, and the liquid (water) is used for the water electrolysis by the water pump 22 again. These members are linked by pipes, and are configured such that the water and the oxygen can flow through necessary paths.

On the hydrogen side path, the hydrogen and produced water having got out of the water electrolysis stack 20 is collected in the gas-liquid separator 25, and is separated into gas and liquid. The gas (hydrogen) is fed to a hydrogen tank 26 through a dehydrator, and is stored. On the other hand, the water (produced water) after the separation by the gas-liquid separator 25 is returned to the gas-liquid separator 21 on the water supply side path through the ion exchanger 27. These members are also linked by pipes, and are configured such that the water and the hydrogen can flow through necessary paths. Further, in the embodiment, there is a flow passage that is connected to the gas-liquid separator 25 and through which the hydrogen is led to a predetermined place by opening and closing of a valve 28. By causing the hydrogen to flow through the flow passage, it is possible to decrease the hydrogen pressure in the hydrogen side path. The valve 28 and the flow passage will be described later.

The electric power source 29 is connected to both electrodes of the water electrolysis stack 20 through electric power source wires. Voltage is applied to the water electrolysis stack 20 by the electric power source 29, and thereby the water electrolyte is performed by the water electrolyte cells 11. Moreover, in the embodiment, the electric power source 29 and the controller 30 are electrically connected, and the controller 30 is configured to be capable of controlling the application voltage of the electric power source 29. The electric power source 29 is known, and a usual electric power source that is used for water electrolysis can be adopted.

### 1.1. Water Electrolysis Stack

As described above, the water electrolysis stack 20 is configured such that the water electrolysis cells 11 are stacked and are sandwiched by the endplates respectively disposed on both ends of the water electrolysis cells 11.

FIG. 2 shows a cross-section of a site in the water electrolysis cell 11 where the water electrolysis is performed. As shown in FIG. 2, the water electrolysis cell 11 has a laminate structure constituted by a plurality of layers. The layer configuration is known, and is not particularly limited. As illustrated in FIG. 2, in the water electrolysis cell 11, a hydrogen electrode catalyst layer 13, a hydrogen electrode diffusion layer 15, and a hydrogen electrode separator 17 are laminated on one side of an electrolyte film 12, and an oxygen electrode catalyst layer 14, an oxygen electrode diffusion layer 16, and an oxygen electrode separator 18 are laminated on the other side of the electrolyte film 12. The hydrogen electrode separator 17 has a wave shape on the cross-section, and forms a groove-shaped hydrogen electrode flow passage 17a between the hydrogen electrode separator 17 and the hydrogen electrode diffusion layer 15. The hydrogen and the produced water flow through the hydrogen electrode flow passage 17a, and is exhausted to the hydrogen side path. On the other hand, the oxygen electrode separator 18 also has a wave shape on the cross-section, and forms a groove-shaped oxygen electrode flow passage 18a between the oxygen electrode separator 18 and the oxygen electrode diffusion layer 16. The water is supplied from the water supply side path to the oxygen electrode flow passage 18a, and the oxygen and the remaining water are exhausted from the oxygen electrode flow passage 18a to the water supply side path.

### 1,2. Controller

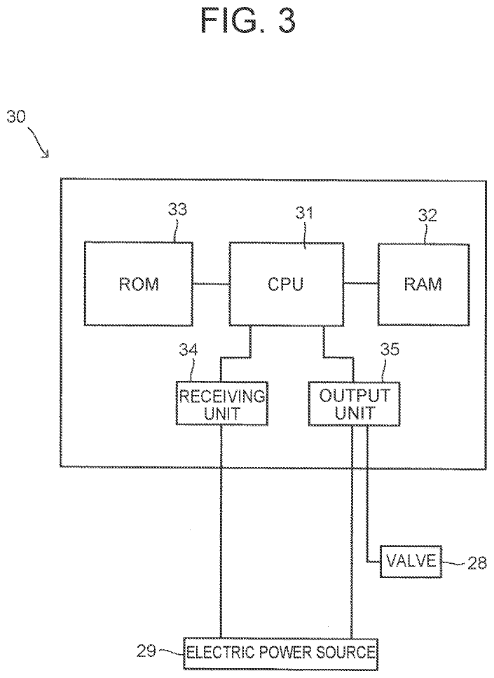

The controller 30 is a controller that controls the water electrolysis apparatus 10 in the embodiment. More specifically, in the embodiment, the controller 30 is a controller that controls at least the application voltage of the electric power source 29 and the opening and closing of the valve 28. However, the controller 30 does not need to be a controller that controls only the application voltage of the electric power source 29 and the opening and closing of the valve 28, and may have another function for controlling the water electrolysis apparatus 10. The aspect of the controller 30 is not particularly limited, and typically can be constituted by a computer. FIG. 3 conceptually shows a configuration example of a computer 30 as the controller 30.

The computer 30 includes a central processing unit (CPU) 31 that is a processor, a random-access memory (RAM) 32 that functions as a working area, a read-only memory (ROM) 33 that serves as a storage medium, a receiving unit 34 that is an interface for inputting information to the computer 30 by wire or by wireless, and an output unit 35 that is an interface for sending information from the computer 30 to the exterior by wire or by wireless. The electric power source 29 is communicably connected to the receiving unit 34 and the output unit 35, and is configured to be capable of controlling the application voltage of the electric power source 29 by the sending and receiving of information through signals. On the other hand, the valve 28 is communicably connected to the output unit 35, and is configured to be capable of controlling the opening and closing of the valve 28.

The computer 30 stores a computer program for executing specific commands that are processes for controls to be performed by the water electrolysis apparatus 10 in the embodiment. In the computer 30, the CPU 31, the RAM 32 and the ROM 33 as hardware resources cooperate with the computer program. Specifically, the CPU 31 realizes functions by executing the computer program recorded in the ROM 33, on the RAM 32 that functions as the working area, based on application voltage information about the electric power source 29 acquired through the receiving unit 34, and the like. Information acquired or generated by the CPU 31 is stored in the RAM 32. Then, based on the obtained result, as necessary, a command is sent to the electric power source 29 or the valve 28 through the output unit 35.

Next, a specific content of the control by the water electrolysis apparatus 10 will be described.

### 2. Control (Application Voltage Control) by Controller

In the water electrolysis apparatus, the hydrogen is exhausted to the hydrogen side path across the water electrolysis cells, and the oxygen is exhausted to the oxygen side path. A leakage (cross leakage) by which some hydrogen enters the oxygen side path occurs in some cases. The amount of the leaked hydrogen should be small, and thus it is desirable to decrease the leaked hydrogen as much as possible. In response, as a result of keen examination, the inventor has known that the ratio of the cross leakage increases in a period after the application of voltage to the water electrolysis stack is started by the electric power source and before the current density reaches a current density (A/cm²) at the time of steady operation, in the case of the time of the startup of the water electrolysis apparatus, and increases in a period after the application of voltage to the water electrolysis stack by the electric power source starts to be decreased and before the stop of the water electrolysis apparatus is completed, in the case of the time of the stop of the water electrolysis apparatus. Moreover, as a result of further keen examination, the inventor has known that the problem of the cross leakage occurs particularly in a range where the current density is low.

Therefore, in the water electrolysis apparatus 10 in the embodiment, the controller 30 controls the application voltage of the electric power source 29 such that the time of the range where the current density is low is as short as possible, at the times of the startup and stop of the water electrolysis apparatus 10. Thereby, it is possible to shorten the current density range where the cross leakage easily occurs, and therefore it is possible to reduce the cross leakage.

### 2.1. Aspect 1

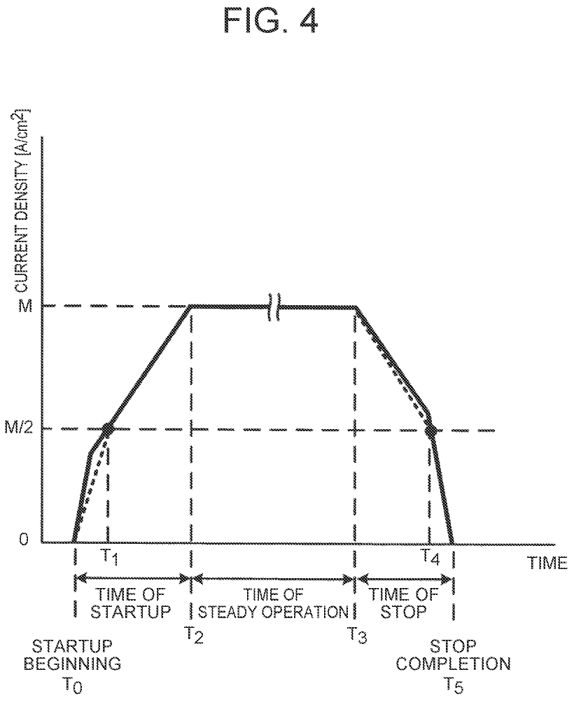

FIG. 4 shows a diagram for describing a control of the application voltage according to an aspect 1. FIG. 4 is a diagram showing a change in current density from the time of the startup to the time of the stop. The abscissa axis indicates time, and the ordinate axis indicates current density. In the control of the application voltage according to the aspect 1, at the times of the startup and stop of the water electrolysis apparatus 10, the controller 30 controls the voltage of the electric power source 29 such that the average change rate of the current density is higher in a region (0 [A/(cm²·second)] or higher and M/2 or lower) where the current density is equal to or lower than half of a current density (M) at the time of the steady operation of the water electrolysis apparatus 10 than in a region (higher than M/2 and M or lower) where the current density is higher than half of the current density (M) at the time of the steady operation.

The current density at “the time of the steady operation” only needs to be a targeted current density when the water electrolysis for the hydrogen and the oxygen is performed by the water electrolysis apparatus 10, or a current density in a range that is allowed as the steady state with respect to the targeted current density. Accordingly, the specific current density at the time of the steady operation is not particularly limited. As an example, a current density in a range of 2.0 [A/cm²] to 3.0 [A/cm²] can be adopted as the targeted value at the time of the steady operation.

Further, the average change rate of the current density can be expressed as the change amount of the current density per unit time, and the unit of the average change rate of the current density is [A/(cm²·second)]. The average change rate is the slope in FIG. 4, and can be calculated as shown in the following description using FIG. 4 as an example. The average change rate of the current density is an absolute value. Here, To denotes a startup beginning time, T₁ denotes a time when the current density becomes M/2 at the time of the startup, T₂ denotes a time when the steady operation starts after the time of the startup, T₃ denotes a time immediately before the stop starts, T₄ denotes a time when the current density becomes M/2 at the time of the stop, and T₅ denotes a stop completion time.
The average change rate of the current density in the region where the current density is equal to or lower than half of the current density at the time of the steady operation in the case of the time of the startup: R₁=(M/2)/(T₁-T₀)
The average change rate of the current density in the region where the current density is higher than half of the current density at the time of the steady operation in the case of the time of the startup: R₂=(M/2)/(T₂-T₁)
The average change rate of the current density in the region where the current density is higher than half of the current density at the time of the steady operation in the case of the time of the stop: R₃=(M/2)/(T₄-T₃)
The average change rate of the current density in the region where the current density is equal to or lower than half of the current density at the time of the steady operation in the case of the time of the stop: R₄=(M/2)/(T₅-T₄)

That is, R₁>R₂ and R₄>R₃ are satisfied. By this control of the application voltage, at the times of the startup and the stop, it is possible to shorten the region where the current density is low and where the cross leakage easily occurs, and it is possible to restrain the occurrence of the cross leakage.

The specific value of the average change rate of the current density in the region where the current density is low (in the embodiment, the region where the current density is M/2 or lower) is not particularly limited, and may be 20 [A/(cm²·second)] or higher and 500 [A/(cm²·second)] or lower. As this value is higher, it is possible to shorten the region where the current density is low. Therefore, 40 [A/(cm²·second)] or higher is preferable, and 60 [A/(cm²·second)] or higher is more preferable. On the other hand, the upper limit of the value is not particularly limited. There is a time delay between the instruction from the controller 30 and the actual achievement of the voltage. As the average change rate of the current density is higher, the delay is larger and therefore a temporary gap is more considerable. Therefore, the upper limit of the value can be set in such a range that it is not mistakenly determined that the gap is an error (for example, a short circuit).

Between the time of the startup and the time of the stop, the value of the average change rate in the region where the current density is low may be the same or may be different.

At the time of the startup, by R₁>R₂, the time of T₁ to T₂ is set so as to be long to some extent. Thereby, it is possible to easily control the change of the rise in water temperature that occurs behind the rise in current density, to efficiently perform the water electrolysis by securing a sufficient warm-up operation time, and to decrease the load on the water electrolysis apparatus 10 from a standpoint of the avoidance of a sudden change. Similarly, at the time of the stop, it is possible to easily control the change of the fall in water temperature that occurs behind the fall in current density, and to decrease the load on the water electrolysis apparatus 10 from a standpoint of the avoidance of a sudden change.

### 2.2. Aspect 2

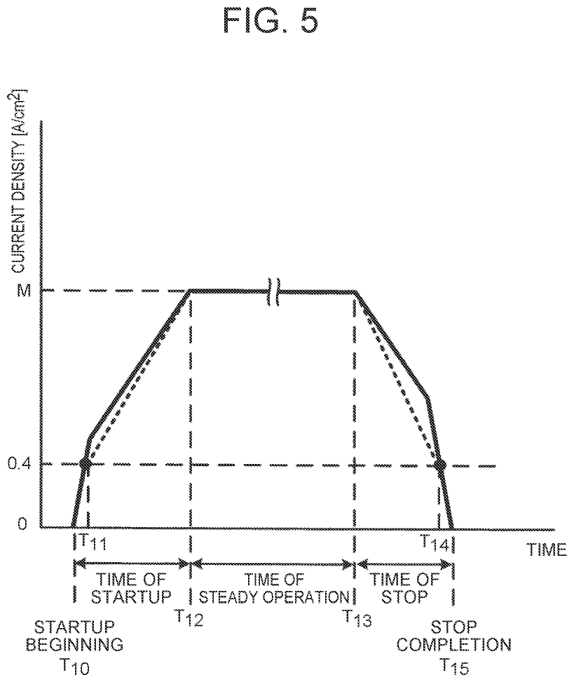

FIG. 5 shows a diagram for describing a control of the application voltage according to an aspect 2. FIG. 5 also is a diagram showing a change in current density from the time of the startup to the time of the stop. The abscissa axis indicates time, and the ordinate axis indicates current density. In the control of the application voltage according to the aspect 2, at the times of the startup and stop of the water electrolysis apparatus 10, the controller 30 controls the electric power source 29 such that the average change rate of the current density is higher in a region where the current density is equal to or lower than 0.4 A/cm² than in a region where the current density is higher than 0.4 A/cm² and is equal to or lower than the current density (M) at the time of the steady operation of the water electrolysis apparatus. The average change rate of the current density in the embodiment can be calculated as shown in the following description using FIG. 5 as an example. Here, T₁₀ denotes a startup beginning time, T₁₁ denotes a time when the current density becomes 0.4 A/cm² at the time of the startup, T₁₂ denotes a time when the steady operation starts after the time of the startup, T₁₃ denotes a time immediately before the stop starts, T₁₄ denotes a time when the current density becomes 0.4 A/cm² at the time of the stop, and T₁₅ denotes a stop completion time.
The average change rate of the current density in the region where the current density is equal to or lower than 0.4 A/cm² in the case of the time of the startup: R₁₁=0.4/(T₁₁-T₁₀)
The average change rate of the current density in the region where the current density is higher than 0.4 A/cm² in the case of the time of the startup: R₁₂=(M-0.4)/(T₁₂-T₁₁)
The average change rate of the current density in the region where the current density is higher than 0.4 A/cm² in the case of the time of the stop: R₁₃=(M-0.4)/(T₁₄-T₁₃)
The average change rate of the current density in the region where the current density is equal to or lower than 0.4 A/cm² in the case of the time of the stop: R₁₄=0.4/(T₁₅-T₁₄)

That is, R₁₁>R₁₂ and R₁₄>R₁₃ are satisfied. By this control of the application voltage, at the times of the startup and the stop, it is possible to shorten the region where the current density is low and where the cross leakage easily occurs, and it is possible to restrain the occurrence of the cross leakage. Inventor's examination has revealed that it is possible to more considerably restrain the occurrence of the cross leakage by increasing the average change rate of the current density in at least the region where the current density is equal to or lower than 0.4 A/cm² and shortening the time (T₁₀ to T₁₁) of the region.

The specific value of the average change rate of the current density in the region where the current density is low (in the embodiment, the region where the current density is equal to or lower than 0.4 A/cm²) is not particularly limited, and may be 20 [A/(cm²·second)] or higher and 500 [A/(cm²·second)] or lower. As this value is higher, it is possible to shorten the region where the current density is low. Therefore, 40 [A/(cm²·second)] or higher is preferable, and 90 [A/(cm²·second)] or higher is more preferable. On the other hand, the upper limit of the value is not particularly limited. There is a time delay between the instruction from the controller 30 and the actual achievement of the voltage. As the average change rate of the current density is higher, the delay is larger and therefore a temporary gap is more considerable. Therefore, the upper limit of the value can be set in such a range that it is not mistakenly determined that the gap is an error (for example, a short circuit).

Between the time of the startup and the time of the stop, the value of the average change rate in the region where the current density is low may be the same or may be different.

At the time of the startup, the average change rate of the current density in the region where the current density is higher than 0.4 A/cm² and where the current density is equal to or lower than M is lower than the average change rate of the current density in the region where the current density is equal to or lower than 0.4 A/cm², and thereby, the time of T₁₁ to T₁₂ is set so as to be long to some extent. Thereby, it is possible to easily control the change of the rise in temperature that occurs behind the rise in current density, to efficiently perform the water electrolysis by securing a sufficient warm-up operation time, and to decrease the load on the water electrolysis apparatus 10 from a standpoint of the avoidance of a sudden change. Similarly, at the time of the stop, it is possible to easily control the change of the fall in temperature that occurs behind the fall in current density, and to decrease the load on the water electrolysis apparatus 10 from a standpoint of the avoidance of a sudden change.

### 2.3. Aspect 3

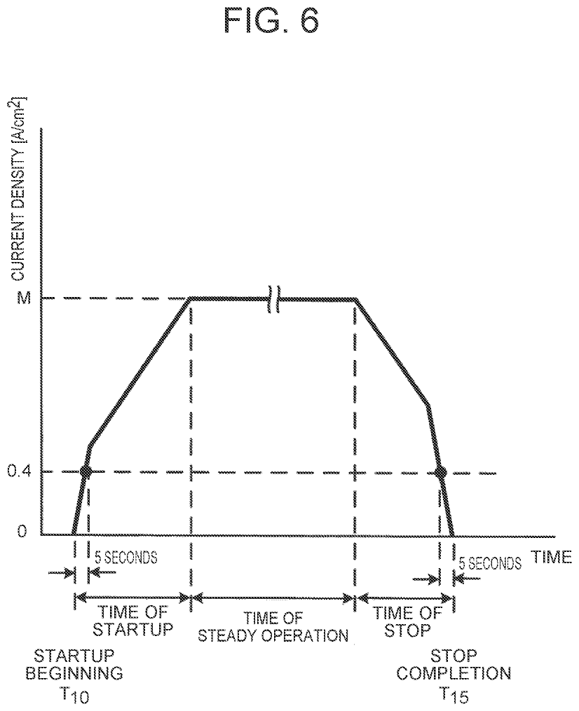

FIG. 6 shows a diagram for describing a control of the application voltage according to an aspect 3. FIG. 6 also is a diagram showing a change in current density from the time of the startup to the time of the stop. The abscissa axis indicates time, and the ordinate axis indicates current density. In the control of the application voltage according to the aspect 3, the controller 30 controls the electric power source 29 such that the current density reaches 0.4 A/cm² within 5 seconds at the time of the startup of the water electrolysis apparatus 10 and the water electrolysis apparatus 10 reaches the stopped state within 5 seconds after the current density reaches 0.4 A/cm² at the time of the stop of the water electrolysis apparatus 10.

In the embodiment, at the times of the startup and the stop, the time for a range where the current density is equal to or higher than 0 A/cm² and is equal to or lower than 0.4 A/cm² is within 5 seconds. Thereby, at the times of the startup and the stop, it is possible to shorten the region where the current density is low and where the cross leakage easily occurs, and it is possible to restrain the occurrence of the cross leakage. Inventor's examination has revealed that it is possible to more considerably restrain the occurrence of the cross leakage by shortening at least the region where the current density is equal to or lower than 0.4 A/cm².

The average change rate of the current density in the region where the current density is low (in the embodiment, the region where the current density is equal to or lower than 0.4 A/cm²) is not particularly limited, and may be 20 [A/(cm²·second)] or higher and 500 [A/(cm²·second)] or lower. As this value is higher, it is possible to shorten the region where the current density is low. Therefore, 40 [A/(cm²·second)] or higher is preferable, and 90 [A/(cm²·second)] or higher is more preferable. On the other hand, the upper limit of the value is not particularly limited. There is a time delay between the instruction from the controller 30 and the actual achievement of the voltage. As the average change rate of the current density is higher, the delay is larger and therefore a temporary gap is more considerable. Therefore, the upper limit of the value can be set in such a range that it is not determined that the gap is an error (for example, a short circuit).

Between the time of the startup and the time of the stop, the value of the average change rate in the region where the current density is low may be the same or may be different.

In the embodiment, at the times of the startup and the stop, the change rate of the current density and time in the ranges where the current density is higher than 0.4 A/cm² are not particularly limited, and the change rate of the current density may be maintained or may be changed. However, by setting the change rate of the current density to a lower change rate in the range where the current density is higher than 0.4 A/cm² than in the range where the current density is equal to or lower than 0.4 A/cm², it is possible to easily control the change of the rise in temperature that occurs behind the rise in current density, to efficiently perform the water electrolysis by securing a sufficient warm-up operation time, and to decrease the load on the water electrolysis apparatus 10 from a standpoint of the avoidance of a sudden change. Similarly, at the time of the stop, it is possible to easily control the change of the fall in temperature that occurs behind the fall in current density, and to decrease the load on the water electrolysis apparatus 10 from a standpoint of the avoidance of a sudden change.

### 3. Control (Valve Control) by Controller

At the time of the stop, the voltage does not decrease sometimes, even when the application voltage of the electric power source 29 is decreased. As a result of keen examination, the inventor has known that the reason why the voltage does not decrease at the time of the stop is because the hydrogen remains in the water electrolysis stack 20. Hence, in the embodiment, the controller 30 decreases the hydrogen pressure of the hydrogen side path by operating the valve 28. Thereby, it is possible to smoothly decrease the voltage at the time of the stop.

The timing when the hydrogen pressure is decreased by operating the valve 28 is not particularly limited. The hydrogen pressure may be decreased by operating the valve 28 at the time of the steady operation before the time of the stop, or before the current density reaches 0.4 A/cm² after the current density starts to be decreased at the time of the stop. The time of the steady operation before the time of the stop is more preferable.

The kind of the valve 28 only needs to be a kind that can decrease the hydrogen pressure of the hydrogen side path and can be actuated by the controller 30. For example, an electromagnetic valve or a regulating valve can be used as the valve 28. Further, the hydrogen exhausted from the valve 28 may be released after being diluted, may be collected in a tank or the like, or may be caused to react with oxygen to be transformed into water and heat for reuse or disposal.

What is claimed is:

1. A water electrolysis apparatus that performs water electrolysis in which hydrogen and oxygen are obtained by supplying water to water electrolysis cells and applying voltage to the water electrolysis cells,
the water electrolysis apparatus comprising:
a water electrolysis stack in which the water electrolysis cells are stacked;
a water supply side path through which water is supplied to the water electrolysis stack;
a hydrogen side path through which hydrogen generated from the water electrolysis stack is collected;
an electric power source that applies the voltage to the water electrolysis stack; and
a controller that controls application voltage of the electric power source, wherein
at times of startup and stop of the water electrolysis apparatus, the controller controls the voltage of the electric power source such that an average change rate of a current density is higher in a region where the current density is equal to or lower than half of a current density at a time of steady operation of the water electrolysis apparatus than in a region where the current density is higher than half of the current density at the time of the steady operation.

2. A water electrolysis apparatus that performs water electrolysis in which hydrogen and oxygen are obtained by supplying water to water electrolysis cells and applying voltage to the water electrolysis cells,
the water electrolysis apparatus comprising:
a water electrolysis stack in which the water electrolysis cells are stacked;
a water supply side path through which water is supplied to the water electrolysis stack;
a hydrogen side path through which hydrogen generated from the water electrolysis stack is collected;
an electric power source that applies the voltage to the water electrolysis stack; and
a controller that controls application voltage of the electric power source, wherein at times of startup and stop of the water electrolysis apparatus, the controller controls
the electric power source such that an average change rate of a current density is higher in a region where the current density is equal to or lower than 0.4 A/cm² than in a region where the current density is higher than 0.4 A/cm² and is equal to or lower than a current density at a time of steady operation of the water electrolysis apparatus.

3. A water electrolysis apparatus that performs water electrolysis in which hydrogen and oxygen are obtained by supplying water to water electrolysis cells and applying voltage to the water electrolysis cells,
the water electrolysis apparatus comprising:
a water electrolysis stack in which the water electrolysis cells are stacked;
a water supply side path through which water is supplied to the water electrolysis stack;
a hydrogen side path through which hydrogen generated from the water electrolysis stack is collected;
an electric power source that applies the voltage to the water electrolysis stack; and
a controller that controls application voltage of the electric power source,
wherein the controller controls the electric power source such that a current density reaches 0.4 A/cm² within 5 seconds at a time of startup of the water electrolysis apparatus and the water electrolysis apparatus reaches a stopped state within 5 seconds after the current density reaches 0.4 A/cm² at a time of stop of the water electrolysis apparatus.

4. The water electrolysis apparatus according to claim 1, wherein:
the water electrolysis apparatus comprises a valve that decreases a hydrogen pressure of the hydrogen side path; and
at the time of the stop of the water electrolysis apparatus, the controller further performs a control to actuate the valve and decrease the hydrogen pressure of the hydrogen side path, before the current density is decreased or before the current density reaches 0.4 A/cm² after the current density starts to be decreased.

5. The water electrolysis apparatus according to claim 2, wherein:
the water electrolysis apparatus comprises a valve that decreases a hydrogen pressure of the hydrogen side path; and
at the time of the stop of the water electrolysis apparatus, the controller further performs a control to actuate the valve and decrease the hydrogen pressure of the hydrogen side path, before the current density is decreased or before the current density reaches 0.4 A/cm² after the current density starts to be decreased.

6. The water electrolysis apparatus according to claim 3, wherein:
the water electrolysis apparatus comprises a valve that decreases a hydrogen pressure of the hydrogen side path; and
at the time of the stop of the water electrolysis apparatus, the controller further performs a control to actuate the valve and decrease the hydrogen pressure of the hydrogen side path, before the current density is decreased or before the current density reaches 0.4 A/cm² after the current density starts to be decreased.
